(19) United States
(12) Patent Application Publication
(10) Pub. No.: US 2016/0352041 A1
(43) Pub. Date: Dec. 1, 2016

(54) ELECTRICAL CONNECTOR HAVING IMPROVED INSULATIVE HOUSING

(71) Applicant: FOXCONN INTERCONNECT TECHNOLOGY LIMITED, Grand Cayman (KY)

(72) Inventors: TAO YAO, HUAIAN (CN); JING-JIE GUO, HUAIAN (CN)

(21) Appl. No.: 15/169,963

(22) Filed: Jun. 1, 2016

(30) Foreign Application Priority Data
Jun. 1, 2015 (CN) 201510291211.X

(51) Int. Cl. H01R 13/516; H01R 43/02; H01R 13/502; H01R 12/70; H01R 13/405

(52) U.S. Cl. CPC H01R 13/516; H01R 12/7076; H01R 13/405; H01R 13/502; H01R 43/0256; H01R 2107/00

(57) ABSTRACT

An electrical connector includes an insulative housing, a number of terminals carried by the insulative housing, a metallic shielding plate retained in the insulative housing, and a shielding shell attached to the insulative housing. The insulative housing has a number of receiving slots located at a back-end thereof. The terminals have a number of soldering portions exposed from the insulative housing. Each receiving slot is located between every two neighboring soldering portions to receive soldering material.

### BACKGROUND OF THE INVENTION

1. Field of the Invention

The present invention relates to an electrical connector including an improved insulative housing with receiving slots for soldering materials.

2. Description of Related Art

Universal Serial Bus (USB) and USB connectors are well known in the art. China Patent No. 204632967 discloses a reversible electrical connector. The electrical connector includes a shielding shell, an insulative housing, a first and second arrays of contacts insert-molded in the housing, a rear plate extending from a rear end of the shielding shell, and a connection connecting the rear plate and the shielding shell. Each of the first array of contacts has a first soldering section extending from the housing and each of the second array of contacts has a second soldering section extending from the housing. The rear plate has a resisting section and an opening located at the resisting section to observe the second soldering sections. The soldering sections of the contacts insert-molded with the housing decrease volatilization of rosin flux mixed in the soldering material in soldering process. As a result, the rosin flux distilled or separated out from the soldering material may accumulate to such an extent as to cause null or empty soldering.

Hence, a new and simple electrical connector is desired.

### SUMMARY OF THE INVENTION

Accordingly, the object of the present invention is to provide an electrical connector comprising: an insulative housing having a plurality of receiving slots located at a back-end thereof; a plurality of terminals carried by the insulative housing, the terminals having a plurality of soldering portions exposed from the insulative housing, each receiving slot being located between every two neighboring soldering portions to receive soldering material; a metallic shielding plate retained in the insulative housing; and a shielding shell attached to the insulative housing.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of an electrical connector;

FIG. 2 is another perspective, assembled view of FIG. 1;

FIG. 3 is a perspective view of the electrical connector separated from a shielding shell and a metal shell;

FIG. 4 is another perspective view similar to FIG. 3;

FIG. 5 is another perspective view similar to FIG. 4;

FIG. 6 is perspective view of an insulative housing, a number of terminals, a shielding plate, and a glue wall of the electrical connector;

FIG. 7 is another perspective view of FIG. 6;

FIG. 8 is a cross-sectional view of the electrical connector along line 8-8 in FIG. 1; and

FIG. 9 is a partly enlarged view of FIG. 4.

### DETAILED DESCRIPTION OF THE PREFERRED EMBODIMENT

Reference will now be made in detail to the preferred embodiment of the present invention.

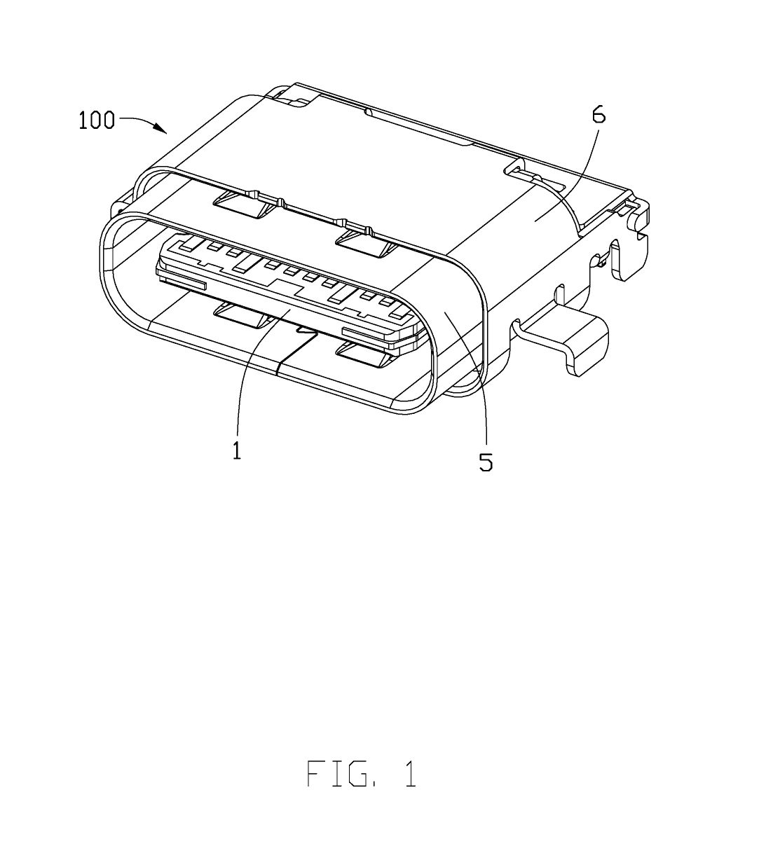

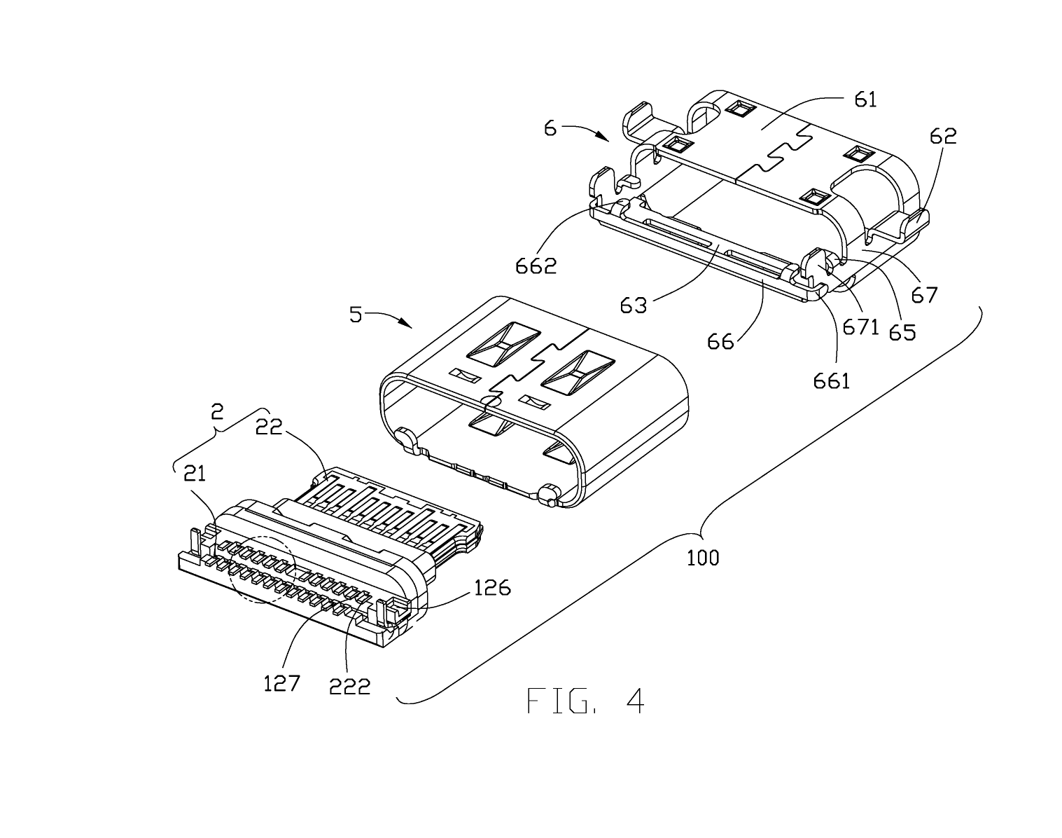

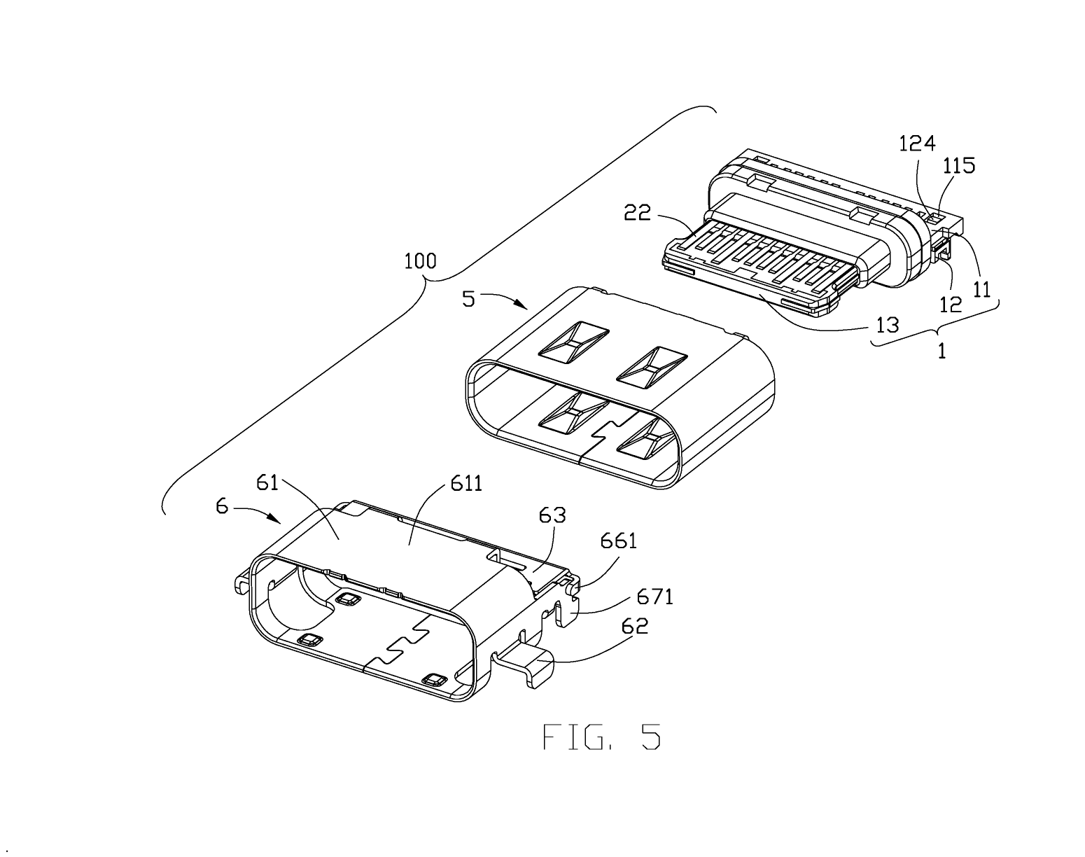

FIGS. 1-9 show an electrical connector 100 mounted upon a printed circuit board 200 and cooperated with a plug connector. For convenience, the electronic connector 100 defines an insertion direction, a transverse direction perpendicular to the insertion direction and forming a horizontal plane therebetween, and an up-and-down direction perpendicular to the insertion direction and the transverse direction in FIG. 1.

The electrical connector 100 includes an insulative housing 1, a number of terminals 2 and a metallic shielding plate 3 retained in the insulative housing 1, a glue wall 4 sealing a back of the insulative housing 1, a shielding shell 5 formed with a mating cavity to receive the insulative housing 1, and a metal shell 6 attached to the shielding shell 5.

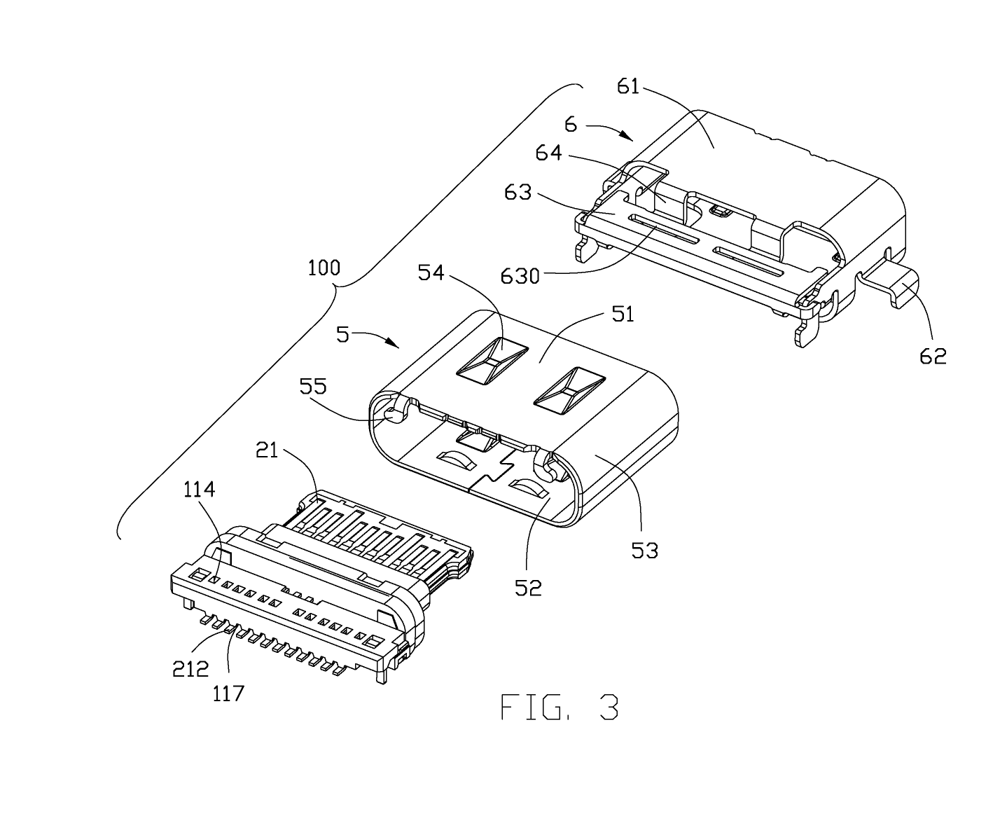

Referring to FIGS. 3-8, the insulative housing 1 includes a first insulative housing 11, a second insulative housing 12, and a third insulative housing 13. The first insulative housing 11 includes a first base portion 111 and a first tongue portion 112 extending forwardly from the first base portion 111. The first base portion 111 has a pair of depression 113 located at two sides thereof, a number of through-holes 114 communicated with an upper surface and the lower surface thereof, and a pair of receiving holes 115 located at two sides of the through-holes 114. The first tongue portion 112 has an aperture 116 located at a front end thereof. The first base portion 111 has a number of first receiving slots 117 located at a rear end thereof to store scaling powders in soldering process.

The second insulative housing 12 includes a second base portion 121 and a second tongue portion 122 extending forwardly from the second base portion 121. The second base portion 121 has a pair of projections 123 extending upwardly and locking the depressions 113 of the first insulative housing 11 and a pair of bumps 124 located at a rear end and protruding to the receiving hole 115. The second base portion 121 has a bulge 125 located at a front end and protruding to the aperture 116. The second base portion 121 has a pair of concaved portions 126 located at two sides of a bottom surface thereof and a number of second receiving slots 127 located at a rear end thereof to store soldering material in soldering process. The first base portion 111 and the second base portion 121 are respectively formed with openings 110, 120. In sealing process, the openings 110,120 are filled by sealing materials to enhance waterproof function. The third insulative housing 13 includes a third base portion 131 and a third tongue portion 132 extending forwardly from the third base portion 131. The third tongue portion 132 defines a hollow section 133 receiving the first tongue portion 112 and the second tongue portion 122 and a sunken portion 134 located at two sides thereof.

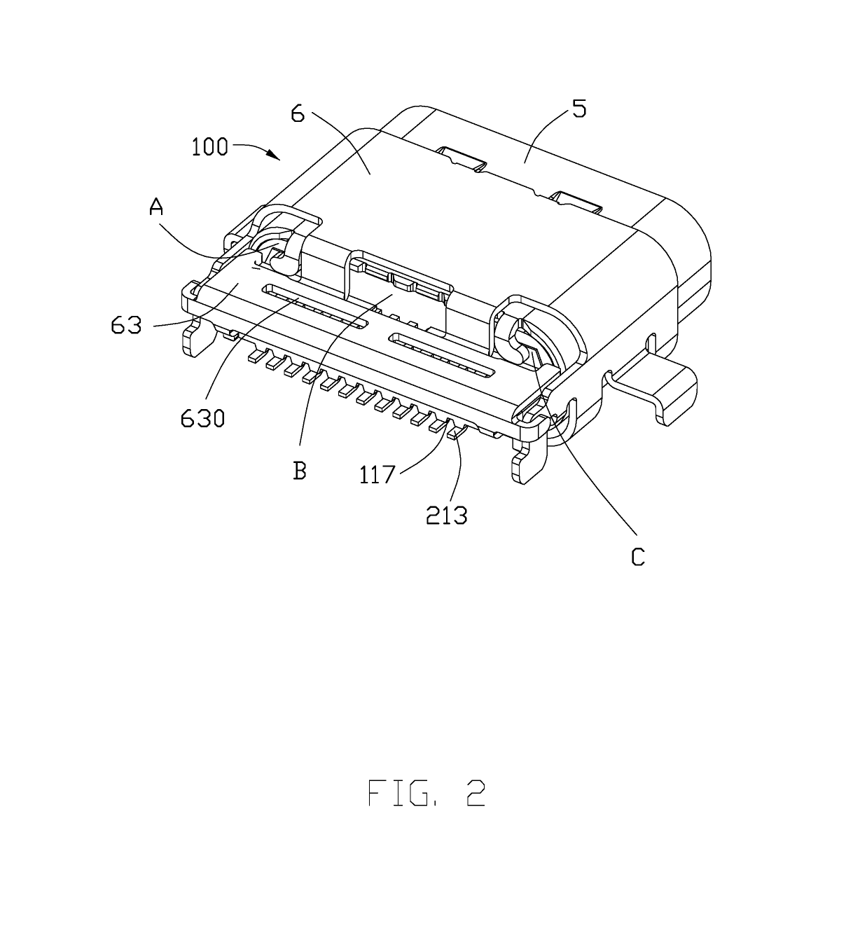

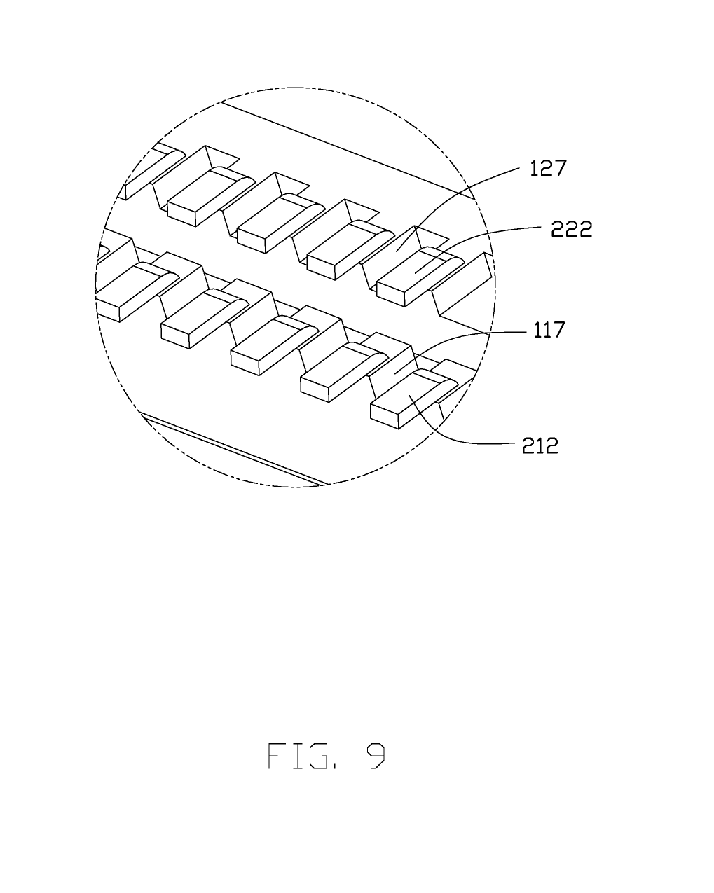

The terminals 2 include a number of first contacts 21 carried by the first tongue portion 112 and a number of second contacts 22 carried by the second tongue portion 122. Each of the first contacts 21 includes a first contacting portion 211 disposed in an upper surface of the first tongue portion 112, and a first soldering portion 212 extending from a back end of the first base portion 111. Each of the second contacts 22 includes a second contacting portion 221 disposed in a bottom surface of the second tongue portion 122, and a second soldering portion 222 extending from a back end of the second base portion 121. Referring to FIG. 2, FIG. 3, and FIG. 9, the first soldering portions 212 are separated by the first receiving slots 117 one by one, and the second soldering portions 222 are separated by the second receiving slots 127 one by one. In other words, every two neighboring first soldering portions 212 have a first receiving slot 117 located therebetween, and every two neighboring second soldering portions 222 have a second receiving slot 127 located therebetween. The first soldering portions 212 and the second soldering portions 222 are located at a same plane and configured in two rows. The two rows of the first soldering portions 212 and the second soldering portions 222 are offset in the transverse direction to observe conveniently the configuration.

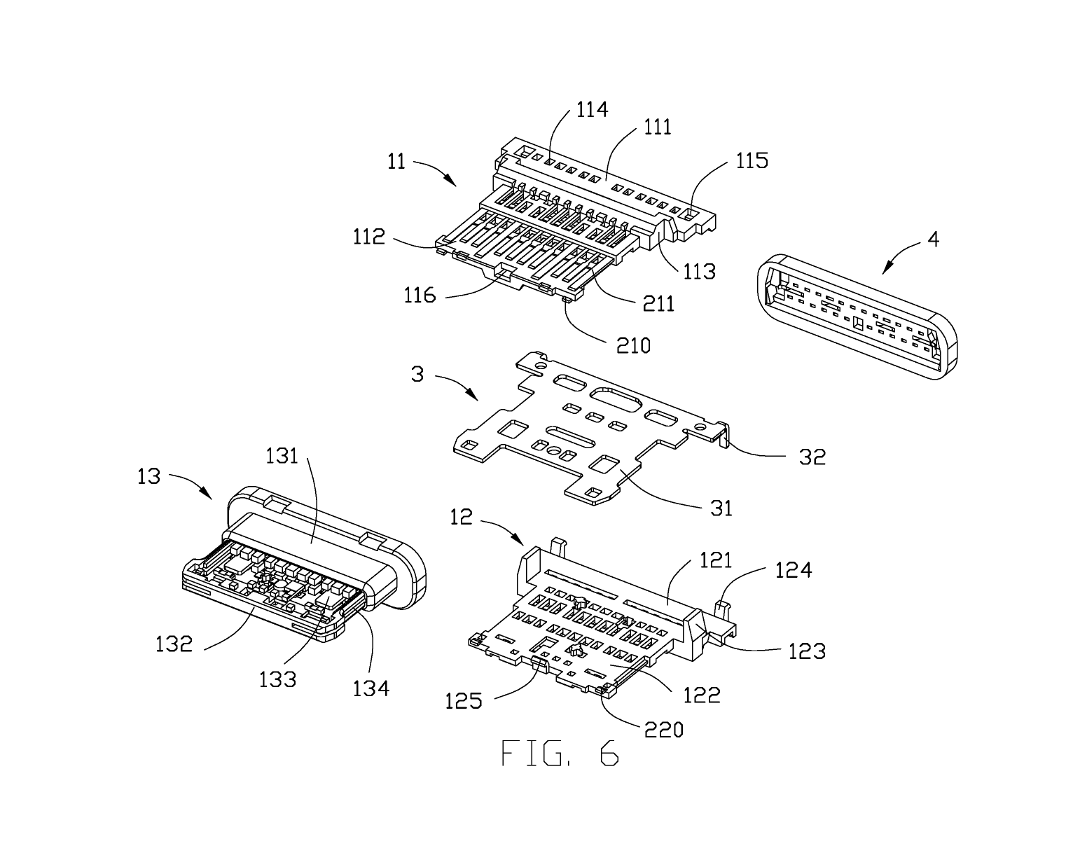

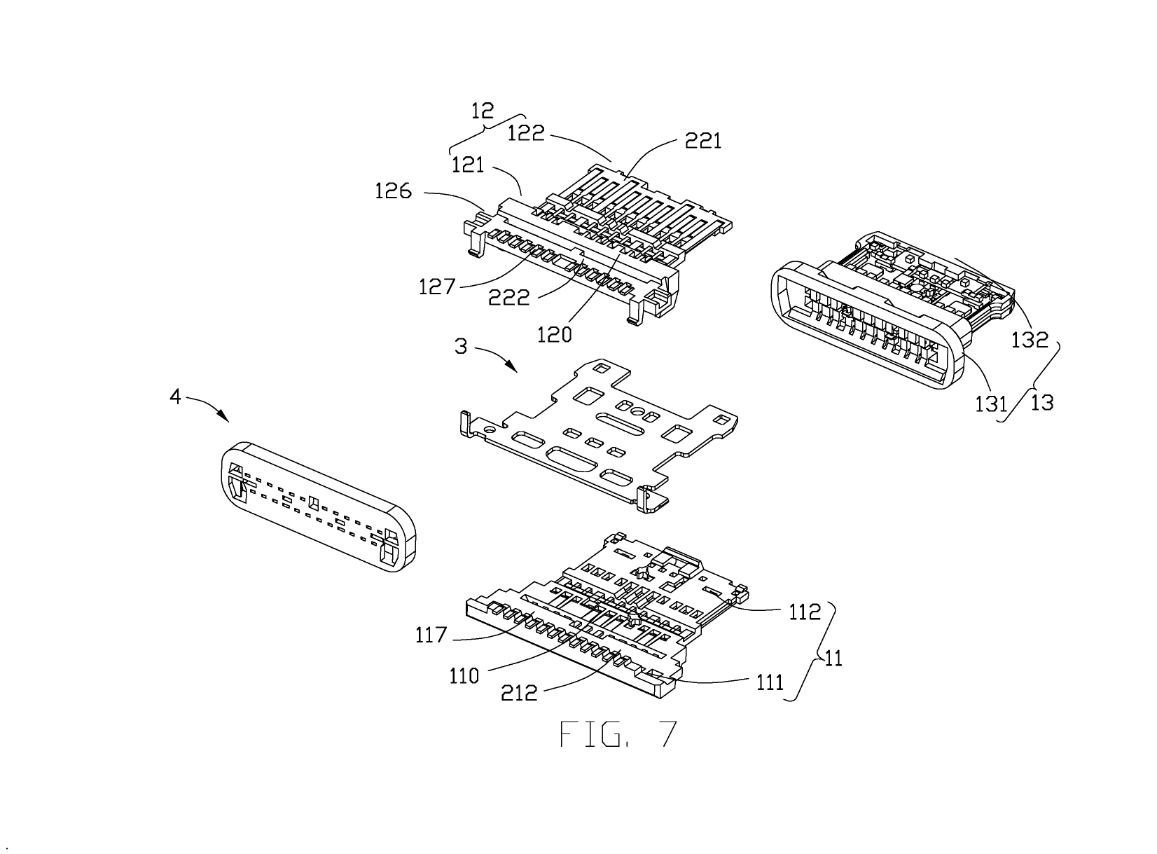

The first contacts 21 and the second contacts 22 are positioned to have 180 degree symmetry such that the corresponding plug connector can be inserted and operatively coupled to the electrical connector 100 in either of two orientations. The first contacts 21 and the second contacts 22 extend in an insertion direction and respectively include four power contacts located forwardly and eight signal contacts located backwardly. The two power contacts in the middle are used to provide electric source and the other two are used for electrical grounding. The eight signal contacts include four super-speed differential contacts located at two sides, two low-speed differential contacts located in the middle, and a pair of controlling contacts. Each of the first contacts 21 is associated with a respective one of the second contacts 22 and is positioned in reverse symmetry with respect to the second contacts 22. Referring to FIGS. 6 and 7, each grounding contact of the first contacts 21 has an end portion 210 bent downwardly and then extending forwardly. Each end portion 210 is located at a front end of each grounding contact of the first contacts 21 and exposed from a lower surface of the first tongue portion 112. Each grounding contact of the second contacts 22 has an edge portion 220 bent downwardly and then extending forwardly. Each edge portion 220 is located at a front end of each grounding contact of the second contacts 22 and exposed from an upper surface of the second tongue portion 122. In manufacture process, each of the end portions 210 and the edge portions 220 is reserved for a extending part exposed from a front end of the insulative housing 1 and then the extending part of each of the end portions 210 and the edge portions 220 is cut after insert-molding process. The end portions 210 and the edge portions 220 are communicated with each other via contacting with the metallic shielding plate 3 to decrease high frequency crosstalk and resonance oscillation.

Referring to FIGS. 6-7, the metallic shielding plate 3, shaping like a panel, includes a supporting section 31 sandwiched between the first tongue portion 112 and the second tongue portion 122, and a first affixed legs 32 extending downwardly from the supporting section 31.

Referring to FIGS. 6-7, the shielding shell 5 includes a top wall 51 and a bottom wall 52 located oppositely, and a pair of side walls 53 connected with the top wall 51 and the bottom wall 52. The top wall 51 and the bottom wall 52 have a number of dimples 54 protruding to the mating cavity to resist a shell of the mating connector and decrease holes exposed from the shielding shell 5 to enhance waterproof function. The top wall 51 has a pair of first clasp sections 55 bent downwardly from a rear end thereof and resisting a back-end of the insulative housing 1.

The metal shell 6 includes a tubular main section 61, a pair of second affixed legs 62, a baffling section 63 extending backwardly, and a pair of connecting section 64 extending in the up-and-down direction and connected with the main section 61 and the baffling section 63. The baffling section 63 has a number of windows 630 communicated with an upper surface and a lower surface and corresponding to the through-hole 114 of the insulative housing 1. The main section 61 defines an upper wall 611 and a pair of lateral walls 67 extending downwardly from the upper wall 611. The lateral wall 67 has a second clasp section 65 bent inwardly and resisting the concaved portion 126. The baffling section 63 has a rear wall 66 bent downwardly. The rear wall 66 has a pair of first resisting arms 661 bent forwardly from two sides thereof and a pair of second resisting arms 662 bent forwardly from a front end thereof. The first resisting arms 661 and the second resisting arms 662 shield behind the insulative housing 1. The lateral wall 67 has a pair of third resisting arms 671 located behind the corresponding second clasp sections 65. The first resisting arms 661 are resisted against by the third resisting arms 671 to affix the baffling section 63 and the main section 61 to enhance the stability of the baffling section 63. The connecting section 64 is separated into two parts which define a hole therebetween to accommodate glues or other sealing materials. The baffling section 63 is perpendicular to the connecting section 64 to form a receiving cavity.

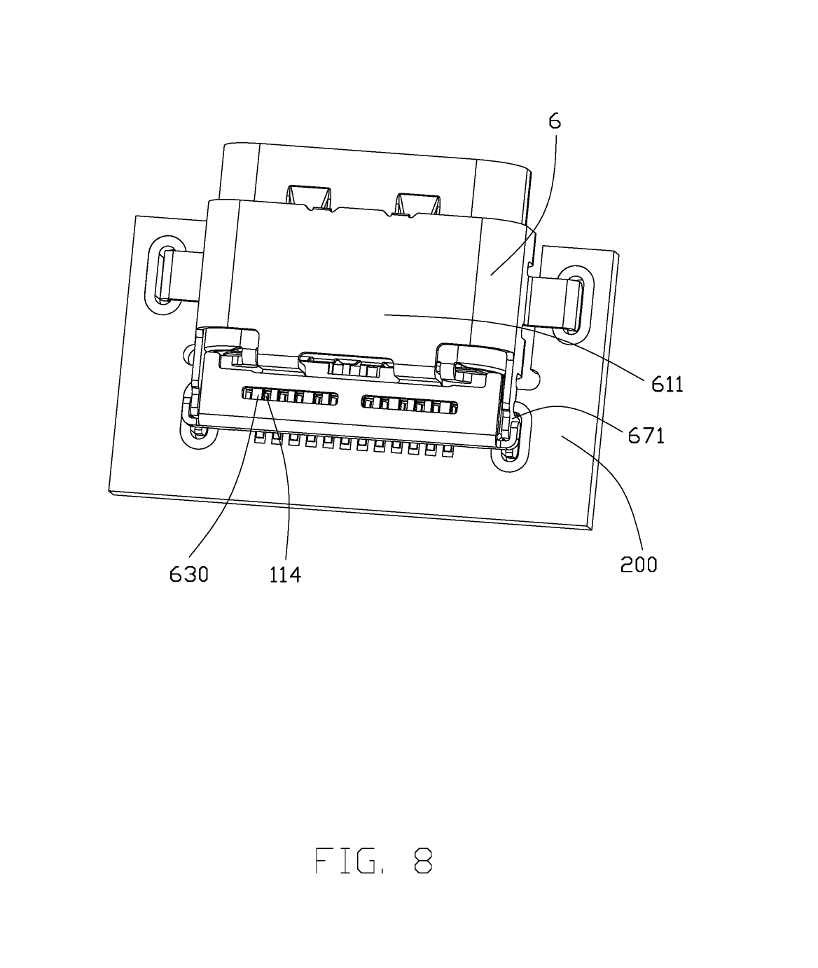

Referring to FIG. 8, the electrical connector 100 is affixed to the printed circuit board 200. The first soldering portions 212 and the second soldering portions 222 are exposed from the through-hole 114 of the insulative housing 1 and the peep door 630 of the metal shell 6 to volatilize the soldering material.

Referring to FIG. 2, the electrical connector 100 defines a first sealing influx A, a second influx B, and a third influx C located at a back-end thereof. The sealing materials pour into the electrical connector 100 from the first sealing influx A, the second influx B, and the third influx C to seal up the terminals 2 exposed from the openings 110,120 and a part between the insulative housing 1 and the shielding shell 5.

However, the disclosure is illustrative only, changes may be made in detail, especially in matter of shape, size, and arrangement of sections within the principles of the invention.

What is claimed is:

1. An electrical connector comprising:
an insulative housing having a plurality of receiving slots located at a back-end thereof;
a plurality of terminals carried by the insulative housing, the terminals having a plurality of soldering portions exposed from the insulative housing, each receiving slot being located between every two neighboring soldering portions to receive soldering material;
a metallic shielding plate retained in the insulative housing; and
a shielding shell attached to the insulative housing.

2. The electrical connector as claimed in claim 1, wherein said insulative housing has a plurality of through-holes communicated with an upper surface and a lower surface of a rear portion thereof, and the first soldering portions and the second soldering portions are exposed from the through-holes to volatilize the soldering material.

3. The electrical connector as claimed in claim 2, wherein said metal shell has a plurality of windows corresponding to the through-holes, and the first soldering portions and the second soldering portions are observable from the windows.

4. The electrical connector as claimed in claim 1, wherein said shielding shell has a top wall and a bottom wall located oppositely, and the top wall and the bottom wall have a plurality of dimples protruding inwardly for resisting a mating connector.

5. The electrical connector as claimed in claim 1, wherein said insulative housing has a plurality of openings, and the openings are filled by sealing materials to seal up the terminals exposed therefrom.

6. The electrical connector as claimed in claim 1, wherein the soldering portions are arranged in inner and outer rows spaced from each other in a front-to-back direction while each of said inner row and said outer row extending along a transverse direction perpendicular to said front-to-back direction, the soldering portions in said inner row and the soldering portions in the outer row being alternately arranged with each other, and the housing forming a row of through holes each extending therethrough in a vertical direction perpendicular to both said front-to-back direction and said transverse direction, said through holes being aligned with the corresponding soldering portions in said inner row in the vertical direction for inspecting soldering status of the corresponding soldering portions, and aligned with the corresponding receiving slots located between the two neighboring soldering portions in the outer row.

7. A method of making an electrical connector assembly, comprising the steps of:
providing an electrical connector, the electrical connector comprising an insulative housing, a plurality of terminals carried by the insulative housing, a metallic shielding plate retained in the insulative housing, and a shielding shell attached to the insulative housing, the insulative housing having a plurality of first receiving slots and a plurality of second receiving slots located at a back-end thereof in two rows along an insertion direction, the terminals having a plurality of first soldering portions and second soldering portions located in two rows along an insertion direction and exposed from the insulative housing, each first receiving slot located between every two neighboring first soldering portions, each second receiving slot located between every two neighboring second soldering portions;
providing a printed circuit board; and
mounting the electrical connector onto the printed circuit board by soldering material, scaling powders of soldering material received in the first receiving slots and the second receiving slots.

8. An electrical connector comprising:
an insulative housing;
a plurality of terminals carried by the insulative housing; and
a metal shell attached to the insulative housing, the metal shell having an upper wall, a pair of lateral walls bent downwardly from the upper wall, a connecting section extending downwardly from a back-end of the upper wall, and a baffling section extending backwardly from a lower end of the connecting section, the baffling section extending along a transverse direction, two sides of the baffling section located close to corresponding lateral walls.

9. The electrical connector as claimed in claim 8, wherein said connecting section is perpendicular to the upper wall and extends along an up-and-down direction to lower the baffling section below the upper wall, the baffling section is perpendicular to the connecting section to form a receiving cavity, and the connecting section has a hole for accommodating glues.

10. The electrical connector as claimed in claim 8, wherein said baffling section has a pair of first resisting arms extending forwardly from a back-end thereof, the lateral walls respectively have a third resisting arm bent downwardly and extending downwardly, and the first resisting arms are respectively resisted against by corresponding third resisting arms.
